(19) United States
(12) Patent Application Publication
(10) Pub. No.: US 2025/0163991 A1
(43) Pub. Date: May 22, 2025

(54) HYDRAULIC BEARING AND METHOD FOR MANUFACTURING A HYDRAULIC BEARING

(71) Applicant: Sumitomo Riko Company Limited, Aichi (JP)

(72) Inventors: Miro Eppli, Bad Soden-Salmünster (DE); Jozsef Kondor, Künzell (DE); Dimitry Khlistunov, Bad Soden-Salmünster (DE)

(73) Assignee: Sumitomo Riko Company Limited, Aichi (JP)

(21) Appl. No.: 18/950,146

(22) Filed: Nov. 17, 2024

(30) Foreign Application Priority Data
Nov. 22, 2023 (DE) 10 2023 132 495.0

(51) Int. Cl. F16F 13/14

(52) U.S. Cl. CPC F16F 13/1481

(57) ABSTRACT

A hydraulic bearing is provided and including: an inner core, a cage surrounding the inner core, an elastomer body extending between the inner core and the cage and elastically connecting them to each other, and an outer sleeve enclosing the cage. The elastomer body has a support spring, first and second radial fluid chamber recesses, and first and second axial fluid chamber recesses. The first and second radial fluid chamber recesses and the first and second axial fluid chamber recesses are each filled with a working fluid and limited radially outwardly by the outer sleeve to form first and second radial fluid chambers, and first and second axial fluid chambers, respectively. The first and second radial fluid chambers are fluidically connected to each other via a radial fluid channel. The first and second axial fluid chambers are fluidically connected to each other via an axial fluid channel.

### CROSS-REFERENCE TO RELATED APPLICATION

This application claims the priority benefit of German application no. 10 2023 132 495.0, filed on Nov. 22, 2023. The entirety of the above-mentioned patent application is hereby incorporated by reference herein and made a part of this specification.

### BACKGROUND

### Technical Field

The disclosure relates to a hydraulic bearing, in particular a hydraulic subframe bearing, and a method for manufacturing a hydraulic bearing, in particular a hydraulic subframe bearing.

### Description of Related Art

Hydraulic bearings are frequently used to connect a first component to a second component, wherein relative movements, in particular vibrations, to one another are permitted but damped. Due to the use of elastomer material, the hydraulic bearing provides restoring spring forces as well as damping forces actively generated by means of dissipation in the bearing. Hydraulic bearings typically have two hydraulic chambers which are connected to each other via a channel to allow fluid exchange between these hydraulic chambers.

In vehicle construction, for example, a subframe for mounting the vehicle cabin and/or drive components is supported with hydraulic bearings in relation to the chassis components to damp road excitation via the chassis to the subframe, in particular in a radial direction. This radial direction depends on the design and position in the vehicle and often corresponds to a horizontal direction of vehicle movement when the hydraulic bearing is in the state of being installed in the vehicle. In many vehicle construction applications, axial damping is dispensed with. Here again, the axial direction depends on the design and position in the vehicle and often corresponds to a vertical direction with respect to the vehicle movement when the hydraulic bearing is in the state of being installed in the vehicle.

If the components to be supported are heavier, such as in combustion engines or electric drives, in addition to radial and/or horizontal movement, post-vibration of the component to be supported in an axial direction will also occur. For e-mobility, the axial stiffness of the bearings is often increased. This often comes with negative acoustic side effects. By using axial damping, there is no need to increase the axial stiffness and the side effects thereof can be reduced. Here, in order to damp these radial and axial movements, two radially damping hydraulic bearings and two axially damping hydraulic bearings are frequently used.

In the prior art, solutions for damping components to be supported in radial and axial directions which integrate damping in both directions in a hydraulic bearing are also known. However, such hydraulic bearings, as described for example in the European patent specifications EP 2,906,851B1 or EP 2,906,852B1, have a high number of components such as four vulcanization groups and 12 other components, the manufacture and combination of which is very complex and cost-intensive. In addition, the radial and axial damping in the solutions shown influence each other since their respective hydraulic compensation chambers are separated from each other by elastic membranes.

Therefore, the present disclosure provides a hydraulic bearing which can be manufactured simply and cost-effectively and which enables damping in the radial and axial directions independently of one another.

### SUMMARY

These above problems are solved by the independent claims. Preferred embodiments result from the respective dependent claims.

A first aspect of the present disclosure relates to a hydraulic bearing including: an inner core; a cage, surrounding the inner core; an elastomer body, extending between the inner core and the cage, and elastically connecting the inner core and the cage to each other; and an outer sleeve, surrounding the cage. The elastomer body has: a support spring; a first radial fluid chamber recess and a second radial fluid chamber recess; and a first axial fluid chamber recess and a second axial fluid chamber recess. The first radial fluid chamber recess, the second radial fluid chamber recess, the first axial fluid chamber recess and the second axial fluid chamber recess are each filled with a working fluid and limited radially outwardly by the outer sleeve to form a first radial fluid chamber, a second radial fluid chamber, a first axial fluid chamber and a second axial fluid chambers, respectively. The first radial fluid chamber and the second radial fluid chamber are fluidically connected to each other via a radial fluid channel and configured such that upon a radial relative movement between the inner core and the cage in a radial direction, a fluid exchange takes place between the first radial fluid chamber and the second radial fluid chamber via the radial fluid channel. The first axial fluid chamber and the second axial fluid chamber are fluidically connected to each another via an axial fluid channel and configured such that upon an axial relative movement between the inner core and the cage in an axial direction, a fluid exchange takes place between the first axial fluid chamber and the second axial fluid chamber via the axial fluid channel.

A second aspect of the present disclosure relates to a method for manufacturing a hydraulic bearing, including: placing an inner core in a mold or a tool; placing a cage in the mold, such that the cage surrounds the inner core; closing the mold; inserting radial sliders into the mold; injecting an elastomer material into the mold; completely vulcanizing the elastomer material in order to form an elastomer body which elastically connects the inner core and the cage, wherein the elastomer body has a support spring, a first radial fluid chamber recess, a second radial fluid chamber recess, a first axial fluid chamber recess and a second axial fluid chamber recess, and molding a vulcanization component, wherein the vulcanization component has the inner core, the elastomer body and the cage; pulling out the radial sliders; opening the mold; demolding the vulcanization component from the mold; and connecting the vulcanization component to an outer sleeve. The first radial fluid chamber recess, the second radial fluid chamber recess, the first axial fluid chamber recess and the second axial fluid chamber recess are each filled with a working fluid and limited radially outwardly by the outer sleeve to form a first radial fluid chamber, a second radial fluid chamber, a first axial fluid chamber and a second axial fluid chamber, respectively. The first radial fluid chamber and the second radial fluid chamber are fluidically connected to each other via a radial fluid channel and configured such that upon a radial relative movement between the inner core and the cage in a radial direction, a fluid exchange takes place between the first radial fluid chamber and the second radial fluid chamber via the radial fluid channel. The first axial fluid chamber and the second axial fluid chamber are fluidically connected to each other via an axial fluid channel and configured such that upon an axial relative movement between the inner core and the cage in an axial direction, a fluid exchange takes place between the first axial fluid chamber and the second axial fluid chamber via the axial fluid channel.

Advantageously, the bearing according to the disclosure can be manufactured more simply, more compactly and more cost-effectively than conventional bearings of this type, in particular as a subframe bearing, while still exhibiting good damping and isolation of vertical and horizontal vibrations. Here, the complexity of the structure is reduced by reducing the number of individual components of the hydraulic bearing and at the same time damping in two independent damping directions is enabled instead of damping in only one of the two directions.

### BRIEF DESCRIPTION OF THE DRAWINGS

FIG. 1A shows a perspective view of an inner core of a hydraulic bearing of the present disclosure.

FIG. 1B shows a perspective view of a cage of the hydraulic bearing of the present disclosure.

FIG. 1C shows a perspective view of an elastomer body of the hydraulic bearing of the present disclosure.

FIG. 2A shows a perspective view of a vulcanization component of the hydraulic bearing of the present disclosure in the connected state of the inner core, the cage and the elastomer body.

FIG. 2B shows a perspective view of an outer sleeve of the hydraulic bearing of the present disclosure.

FIG. 2C shows a perspective view of the hydraulic bearing of the present disclosure in the connected state of the vulcanization component and the outer sleeve.

FIG. 3 shows a front view of an axial end face of the vulcanization component of the hydraulic bearing of the present disclosure.

FIG. 4 shows a first side view of the vulcanization component of the hydraulic bearing of the present disclosure.

FIG. 5 shows a cross-sectional view of the vulcanization component of the hydraulic bearing of the present disclosure of FIG. 4.

FIG. 6 shows a second side view of the vulcanization component of the hydraulic bearing of the present disclosure.

FIG. 7 shows a cross-sectional view of the vulcanization component of the hydraulic bearing of the present disclosure of FIG. 6.

FIG. 8 shows a schematic cross-sectional view of the vulcanization component of the hydraulic bearing of the present disclosure under axial load.

### DESCRIPTION OF THE EMBODIMENTS

A first aspect of the present disclosure relates to a hydraulic bearing 10 including: an inner core 20; a cage 30, surrounding the inner core 20; an elastomer body 40, extending between the inner core 20 and the cage 30, and elastically connecting the inner core 20 and the cage 30 to each other; and an outer sleeve 50, surrounding the cage 30. The elastomer body 40 has: a support spring 60; a first radial fluid chamber recess 70 and a second radial fluid chamber recess 72; and a first axial fluid chamber recess 80 and a second axial fluid chamber recess 82. The first radial fluid chamber recess 70, the second radial fluid chamber recess 72, the first axial fluid chamber recess 80 and the second axial fluid chamber recess 82 are each filled with a working fluid 90 and limited radially outwardly by the outer sleeve 50 to form a first radial fluid chamber 74, a second radial fluid chamber 76, a first axial fluid chamber 84 and a second axial fluid chambers 86, respectively. The first radial fluid chamber 74 and the second radial fluid chamber 76 are fluidically connected to each other via a radial fluid channel 78 and configured such that upon a radial relative movement between the inner core 20 and the cage 30 in a radial direction VR, a fluid exchange takes place between the first radial fluid chamber 74 and the second radial fluid chamber 76 via the radial fluid channel 78. The first axial fluid chamber 84 and the second axial fluid chamber 86 are fluidically connected to each another via an axial fluid channel 88 and configured such that upon an axial relative movement between the inner core 20 and the cage 30 in an axial direction AR, a fluid exchange takes place between the first axial fluid chamber 84 and the second axial fluid chamber 86 via the axial fluid channel 88.

Advantageously, the bearing according to the disclosure can be manufactured more simply, more compactly and more cost-effectively than conventional bearings of this type, in particular as a subframe bearing, while still exhibiting good damping and isolation of vertical and horizontal vibrations. Here, the complexity of the structure is reduced by reducing the number of individual components of the hydraulic bearing and at the same time damping in two independent damping directions is enabled instead of damping in only one of the two directions.

In the context of this application, all indications of spatial direction “up”, “down” and “vertical” refer to the z-axis of a three-dimensional coordinate system whose origin lies approximately in the center of mass of the bearing according to the disclosure and which is oriented in such a way that the z-axis represents one of the main axes of inertia of the bearing. Accordingly, the indication “axial” on the one hand refers to the z-axis and the indication “radial” on the other hand refers to the x-y plane, spanned by the x- and y-axes of the coordinate system, which extends orthogonally to the z-axis. That is, “radial” refers to directional indications perpendicular to the z-axis. The indication “horizontal” also refers to the x-y plane. In the case of the bearing according to the disclosure, the indication “transverse” refers to directions along the x-y plane or parallel to the x-y plane, while the indication “longitudinal” refers to the directions along or parallel to the z-axis.

The term “surrounded” in the context of this application can mean that the cage of the bearing according to the disclosure frames, fences or encircles the inner core and partially limits the inner core in the radial direction and in the circumferential direction around the z-axis. That is, in a state of the bearing without an elastomer body, the cage may constitute a radial boundary for the inner core. On the other hand, the term “enclose” in the context of this application can mean that the outer sleeve completely limits the cage in the radial direction and in the circumferential direction for the height of the cage in the vertical direction and thus encases the cage.

The hydraulic bearing has an outer sleeve and a vulcanization component, wherein the outer sleeve at least partially encloses the vulcanization component. The hydraulic bearing or the outer sleeve may be cylindrical or substantially cylindrical. However, the hydraulic bearing may also be conically tapered or approximately conically tapered, or the axial end faces of the hydraulic bearing may also be formed to be elliptical, rectangular or in a shape suitable for a hydraulic bearing instead of a circular shape. The hydraulic bearing may also be referred to as a hydro-bearing.

The vulcanization component of the hydraulic bearing may have at least the inner core, the cage and the elastomer body. The outer shape of the vulcanization component is formed such that the vulcanization component can be press-fitted into the outer sleeve in the manufacture of the hydraulic bearing and the inner side of the outer sleeve surrounds and/or limits the vulcanization component to the outside. The inner core of the vulcanization component is surrounded by the cage at least in the radial direction, and the elastomer body elastically connects the inner core to the cage. In particular, the inner core and the cage are partially or completely embedded in the elastomer body. Here, both axial elastomer stops and radial sealing elements may project beyond the inner core and/or the cage in the axial and/or radial direction. In order to manufacture the vulcanization component, the inner core and the cage may be inserted in a common mold, in particular concentrically, and overmolded with elastomer material using the injection molding method. In other words, the elastomer body may be vulcanized onto the cage and/or the inner core. The elastomer material may form the elastomer body and the vulcanization component may be removed from the mold as a single component. Here, other manufacturing methods may also be used in addition to or instead of the injection molding method. For example, a low-pressure casting method or a similar method may also be used to manufacture the vulcanization component with an elastomer material that is not rubber-based.

The inner core may be shaped from a dimensionally stable material such as a metal or plastic, in particular aluminum. The inner core may be formed to be substantially cylindrical and extend in the axial direction of the bearing. In the inner core, an axial through hole may be formed as a mounting recess. The cross-sectional shape of the inner core is not limited to a circular shape and may have a changing cross-sectional shape along the axial direction. In particular, the inner core may have a pair of radially protruding thickenings which are offset from each other in the axial direction and arranged opposite each other in the radial direction. These thickenings may be configured to increase the axial stiffness of the bearing and/or to support the deformation or volume change of the axial fluid chambers upon axial relative movement between the inner core and the cage. The inner core may have a pair of radial stop protrusions, each of which extends in the radial direction into the corresponding radial fluid chambers and limits relative displacement of the inner core and the cage with respect to each other in the radial direction. The radial stop protrusions may also be referred to as radial stops and are arranged in particular opposite each other in the radial direction, in particular diametrically to each other, and extend in opposite radial directions. The radial extension directions of the radial stop protrusions are in particular offset by approximately 90° to the radial extension directions of the thickenings.

The elastomer body is formed, for example, from an elastically deformable plastic such as an elastomer, which can deform elastically under load. The elastomer body comprises a support spring or forms a support spring. The support spring of the elastomer body may be substantially axially aligned and may generate a spring force counteracting the load in the axial and radial directions under tensile and compressive load. The elastomer body may completely or at least partially surround and/or embed the inner core and/or the cage. The elastomer body has two radial fluid chamber recesses and two axial fluid chamber recesses. The elastomer body may form at least a part of a radial fluid channel which connects the radial fluid chamber recesses and/or may form at least a part of an axial fluid channel which connects the axial fluid chamber recesses. The two radial fluid chamber recesses are each not connected to one or two of the axial fluid chamber recesses in the elastomer body.

The cage may be formed as a hollow cylinder or approximately as a hollow cylinder in its basic shape. Here, the cage may be formed at least partially from a dimensionally stable material such as a plastic and/or a metal such as aluminum, for example. The cage may in particular be manufacturable using the injection molding method or (die) casting method. The axial end faces of the cage, i.e. the surfaces at the two ends of the longitudinal axis which expand perpendicularly to the longitudinal axis to the outside of the cage, may be open or at least partially limit the cage in the direction of the longitudinal axis. The axial end faces of the cage may be substantially completely covered with the material of the elastomer body. The cage may in particular be substantially completely embedded in the elastomer body. Radially outwards, however, the cage may also be at least partially exposed to be able to be better connected to the outer sleeve. In the radial direction, i.e. from the inside of the cage to the outside of the cage, the cage has, for example, two or four windows or through recesses which are provided to form at least two radial fluid chambers and two axial fluid chambers each for receiving a working fluid. In addition, the cage may at least partially form radial fluid channels and/or axial fluid channels which extend between the respective fluid chambers.

The outer sleeve may be formed at least partially from a dimensionally stable material such as a metal or plastic, for example, which is suitable for fastening to an external component such as a body part subject to a vibration load, for example. The outer sleeve may be formed as a hollow cylinder or substantially as a hollow cylinder. The outer sleeve may have an axial extension which substantially corresponds to the axial extension of the cage and/or the elastomer body. The outer sleeve may also have fixing structures which are suitable for fixing the outer sleeve to an external component. For example, the outer sleeve may be connected to a flange to connect the hydraulic bearing to a vehicle frame. The outer sleeve may also have sealing lips, continuous in the circumferential direction, respectively, at its axial ends, for example. The vulcanization component may be press-fitted into the outer sleeve and fixed in a force-fitting manner in the outer sleeve. However, the axial ends of the outer sleeve may also be crimped after press-fitting the vulcanization body to fix the vulcanization component in a force-fitting manner in the outer sleeve.

In an assembled state of the hydraulic bearing, in which the vulcanization component has already been pressed into the outer sleeve, the two radial fluid chamber recesses, together with a part of the inside of the outer sleeve, each form a radial fluid chamber, elastic in the region of the elastomer body, which are connected via the radial fluid channel, wherein the radial fluid system formed therefrom is configured to be fluid-tight and is filled with a working fluid. The first and second radial fluid chambers may each be at least partially limited outwardly in the radial direction by the outer sleeve, while the first and second radial fluid chambers are at least partially limited inwardly in the radial direction by the elastomer body, in both axial directions and in both peripheral directions. In particular, the radial fluid chambers may each be delimited from the environment in both axial directions by membranes, wherein the membranes may be part of the elastomer body. Here, a radial fluid chamber recess and a window of the cage may, in each case, lie at least partially one above the other in the radial direction, and the radial fluid channel may be formed on the outer side of the cage between the cage and the outer sleeve. The two radial fluid chambers may then communicate fluidically with each other via the radial fluid channel, wherein upon radial relative movement between the inner core and the cage, the volume of one radial fluid chamber is decreased in the region of its elastic radial fluid chamber recess and the volume of the elastic radial fluid chamber recess of the other radial fluid chamber is increased, so that working fluid flows into the other radial fluid chamber via the radial fluid channel. The radial relative movement between the inner core and the cage can be damped by virtue of the fluidic communication of the two radial fluid chambers.

In addition, the two axial fluid chamber recesses, together with a part of the inside of the outer sleeve, each form an axial fluid chamber, elastic in the region of the elastomer body, which are connected via the axial fluid channel, wherein the axial fluid system formed therefrom is configured to be fluid-tight and is filled with a working fluid. The first and second axial fluid chambers are each at least partially limited outwardly in the radial direction by the outer sleeve, while the first and second axial fluid chambers are at least partially limited inwardly in the radial direction by the elastomer body, in both axial directions and in both peripheral directions. In particular, the first axial fluid chamber may be limited in one axial direction by a membrane and in the other axial direction by the support spring, whereas the second axial fluid chamber may be limited in the other axial direction by a membrane and in the one axial direction by the support spring, wherein the membranes may be part of the elastomer body. Here, an axial fluid chamber recess and a window of the cage may, in each case, lie at least partially one above the other in the radial direction and the axial fluid channel may be formed on the outer side of the cage between the cage and the outer sleeve. The two axial fluid chambers may then communicate fluidically with each other via the axial fluid channel, wherein upon axial relative movement between the inner core and the cage, the volume of one axial fluid chamber is decreased in the region of its elastic axial fluid chamber recess and the volume of the elastic axial fluid chamber recess of the other axial fluid chamber is increased, so that working fluid flows into the other axial fluid chamber via the axial fluid channel. The axial relative movement between the inner core and the cage can be damped by virtue of the fluidic communication of the two axial fluid chambers.

Advantageously, the damping of the bearing in the radial direction may be influenced by the geometry of the radial fluid channel, in particular by the length and/or the cross-section of the radial fluid channel. Similarly, the damping of the bearing in the axial direction may be influenced by the geometry of the axial fluid channel, in particular by the length and/or the cross-section of the axial fluid channel. For example, the damping of the bearing can be increased by increasing the length of the respective fluid channel and/or increasing the cross-section of the bearing. It is also possible to vary the number of fluid channels.

In an embodiment of the hydraulic bearing 10, the elastomer body 40 is provided to be substantially free of undercuts on its axial end faces in the axial direction AR, and/or the elastomer body 40 and the cage 30 are provided to be substantially free of undercuts in a region of the first radial fluid chamber recess 70, the second radial fluid chamber recess 72, the first axial fluid chamber recess 80 and the second axial fluid chamber recess 82 at least in a first radial direction +VR and a second radial direction −VR opposing each other. The radial direction VR includes the first radial direction +VR and the second radial direction −VR opposing each other.

Advantageously, the hydraulic bearing can be produced compactly and much more easily because its vulcanization component can be produced in one manufacturing step in an injection mold or a casting mold. Here, the geometry of the axial end faces of the elastomer body, its radial fluid chamber recesses and axial fluid chamber recesses and, if necessary, the radial fluid channels and/or the axial fluid channels are formed without additional incorporation steps. This is achieved by the axial end faces in the axial direction and the fluid chamber recesses and, if necessary, the fluid channels of the elastomer body in the radial direction being provided to be substantially free of undercuts.

“Provided to be substantially free of undercuts” means in particular that there is no undercut in the corresponding direction in the manufacture of the elastomer body or in the unloaded state of the elastomer body, or that there is only a small amount of undercut, in particular only in easily deformable regions of the elastomer body. Furthermore, “provided to be substantially free of undercuts” can mean that there is no undercut on the elastomer body in an assembled state of the bearing, or that there is only a small amount of undercut on the elastomer body, in particular only in easily deformable regions of the elastomer body. “Substantially free of undercuts” can mean in particular that it is possible to pull out a slider in the corresponding direction in the manufacture of the elastomer body without damaging or destroying the elastomer body.

In order to manufacture the elastomer body for the vulcanization component of the bearing, an injection mold may be used which at least partially encloses the vulcanization component during injection molding and which is opened after completion to be able to remove the vulcanization component. Here, an inner side of this mold represents the counterpart to a part of the desired outer contour of the vulcanization component before being press-fitted into the outer sleeve, in particular the axial end faces and a part of the lateral surface of the vulcanization component which abuts against the inner side of the outer sleeve in the pressed state. Here, in the region of the lateral surface, the mold has openings or passages into or through which appropriately shaped sliders are insertable into the interior of the mold in two predetermined, mutually opposite radial directions. These sliders have a shape which, in a state of being inserted into the interior of the mold, forms the shape of the two radial fluid chamber recesses and the shape of the two axial fluid chamber recesses. The sliders may also have portions which enclose the cage and form the radial outer surface of the elastomer body or the vulcanization component, in particular also the radial fluid channels and/or axial fluid channels.

In the manufacture of the vulcanization component using the injection mold, the inner core and the cage of the hydraulic bearing may first be introduced into the interior of the mold. The inner core and the cage are brought into a predetermined position with respect to each other inside the mold before injection molding. This predetermined position corresponds to the position of the inner core and the cage in an unloaded state of the hydraulic bearing. In particular, in the predetermined position, the axial direction of the inner core or the cage corresponds approximately to the opening or closing direction of the mold, whereas a specific radial direction of the inner core or the cage corresponds approximately to the slide-in or slide-out direction of one of the sliders. In addition, the windows of the cage are aligned inside the mold such that the sliders can be inserted through the respective windows to an end position in which the sliders form the counterpart to the desired radial fluid chamber recesses and axial fluid chamber recesses, respectively. After inserting the sliders, the elastomer material may be injected and vulcanized into the remaining cavity between the inner contour of the mold, the inner core, the cage and the slider using the injection molding method. Subsequently, the sliders may be removed from the inside of the mold in the opposite direction and the finished vulcanization component may be removed from the inside of the mold and press-fitted into the outer sleeve in the next step.

In another embodiment of the hydraulic bearing 10, the support spring 60 has a first support spring arm 62 and a second support spring arm 64 each extending from the inner core 20 to the cage 30 at substantially diametrical positions. The first radial fluid chamber 74 and the second radial fluid chamber 76 are limited in a circumferential direction by the first support spring arm 62 and the second support spring arm 64. The first axial fluid chamber 84 is limited by the first support spring arm 62 and the second axial fluid chamber 86 is limited by the second support spring arm 64 in the axial direction AR.

Here, the two diametrically arranged support spring arms offer the advantage of a more uniform stability and damping of the hydraulic bearing in the axial direction with simple manufacture.

Here, a substantially diametrical position of the first and second support spring arms can mean a substantially point-symmetrical arrangement of the support spring arms with respect to a center point of the hydraulic bearing in the axial extension of the hydraulic bearing on the z-axis. The center point of the hydraulic bearing may also be located in its center of volume and/or its center of area in an xy-plane.

The first support spring arm is radially separated from the second support spring arm by the inner core. The hydraulic bearing preferably damps radial relative movement between the inner core and the cage perpendicular to the separating plane formed by the support spring arms. When using the hydraulic bearing in which damping is desired preferably in a specific radial direction, the hydraulic bearing according to the disclosure may be installed in a corresponding orientation. In the two opposite axial directions, on the other hand, the first and second radial fluid chambers are each limited only by a membrane formed by the elastomer body, but not by the associated first or second support spring arm. The first and second axial fluid chambers may each be delimited from the first and second radial fluid chambers in a circumferential direction by a further partition wall formed by the elastomer body, which has a significantly lower material thickness than the support spring arms. However, the partition walls may be configured to be so stable that the radial and axial fluid chambers do not significantly influence each other during operation. However, it is also conceivable to provide membranes instead of partitions. In an axial direction, the radial fluid chambers and axial fluid chambers may be formed to be substantially free of overlap and thus also without significant mutual influence during operation of the hydraulic bearing.

In a further embodiment of the hydraulic bearing 10, the first axial fluid chamber 84 is arranged on a side of a first axial bearing end 12 of the first support spring arm 62, and the second axial fluid chamber 86 is arranged on a side of a second axial bearing end 14 of the second support spring arm 64.

In other words, the first axial fluid chamber and the second axial fluid chamber are each arranged offset towards a different axial end of the bearing. Due to the offset axial arrangement of the first and second axial fluid chambers substantially below an end of the respective first and second support spring arms, high fluid exchange between the axial fluid chambers can be ensured upon axial displacement and thus good damping properties of the axial fluid system can be achieved.

Here, the first axial fluid chamber and the second axial fluid chamber may in turn occupy a substantially diametrical position with respect to a center point of the hydraulic bearing, for example its center of volume and/or its center of area in an xy-plane. Here, the respective axial fluid chamber may be arranged completely below a first support spring arm end of the associated support spring arm and/or between a first axial bearing end and the first support spring arm end, wherein a second support spring arm end of the support spring arm may be arranged at a second axial bearing end.

In another embodiment of the hydraulic bearing 10, the inner core 20 has a first radially protruding thickening region 24 and a second radially protruding thickening region 25. The first radially protruding thickening region 24 is provided in the circumferential direction at a position corresponding to the first support spring arm 62. The second radially protruding thickening region 25 is provided in the circumferential direction at a position corresponding to the second support spring arm 64. The first radially protruding thickening region 24 is offset in the axial direction AR relative to the second radially protruding thickening region 25 towards the first axial bearing end 12.

Here, due to the diametrical arrangement, the second radially protruding thickening region is also offset in the axial direction relative to the first radially protruding thickening region towards the second axial bearing end.

By virtue of the first and second radially protruding thickening regions of the inner core, axial stiffness of the bearing can be easily increased or adjusted. In particular, the thickening regions are also configured such that deformation of the axial fluid chambers is supported or reinforced upon axial displacement of the inner core with respect to the cage.

In another embodiment of the hydraulic bearing 10, the first radially protruding thickening region 24 has a first pressing surface 26 which, at least in sections, adjoins the first axial fluid chamber 84 in the axial direction AR. The second radially protruding thickening region 25 has a second pressing surface 27 which, at least in sections, adjoins the second axial fluid chamber 86 in the axial direction AR.

Here, the first pressing surface of the first radially protruding thickening region may substantially face the first bearing end in the axial direction, and the second pressing surface of the second radially protruding thickening region may substantially face the second bearing end in the axial direction.

The pressing surfaces of the thickening regions offer the advantage, in particular upon axial relative movement of the inner core with respect to the cage, that, depending on the axial direction of the relative movement, one of the two pressing surfaces improves the expulsion of the working fluid from one of the axial fluid chambers via the axial fluid channel into the other axial fluid chamber. Here, it is also advantageous if the pressing surfaces of the thickening regions consist of a non-elastic material and do not deform during the expulsion of the working liquid.

In another embodiment of the hydraulic bearing 10, the cage 30 has a first support protrusion 32 disposed at the second axial bearing end 14 and a second support protrusion 34 disposed at the first axial bearing end 12. The first support protrusion 32 is provided in the circumferential direction at a position corresponding to the first support spring arm 62, and the second support protrusion 34 is provided in the circumferential direction at a position corresponding to the second support spring arm 64.

Here, the first and second support protrusions of the cage may each extend radially inwards from a radial inner side of the cage. The first and second support protrusions may each substantially have a wedge shape in cross-section along the z-axis, protruding most radially inwards towards the axial end of the cage. In addition, the first or second thickening region of the inner core and the first or second support protrusion of the cage may clamp or pinch the first or second support spring arm at least in sections therebetween, whereby the axial stiffness of the bearing can be increased.

A second aspect of the present disclosure relates to a method for manufacturing a hydraulic bearing 10, including: placing an inner core 20 in a mold or a tool; placing a cage 30 in the mold such that the cage 30 surrounds the inner core 20; closing the mold; inserting radial sliders into the mold; injecting an elastomer material into the mold; completely vulcanizing the elastomer material in order to form an elastomer body 40 which elastically connects the inner core 20 and the cage 30, and the elastomer body 40 has a support spring 60, a first radial fluid chamber recess 70, a second radial fluid chamber recess 72, a first axial fluid chamber recess 80 and a second axial fluid chamber recess 82, and molding a vulcanization component 100, in which the vulcanization component 100 has the inner core 20, the elastomer body 40 and the cage 30; pulling out the radial sliders; opening the mold; demolding the vulcanization component 100 from the mold; and connecting the vulcanization component 100 to an outer sleeve 50. The first radial fluid chamber recess 70, the second radial fluid chamber recess 72, the first axial fluid chamber recess 80 and the second axial fluid chamber recess 82 are each filled with a working fluid 90 and limited radially outwardly by the outer sleeve 50 to form a first radial fluid chamber 74, a second radial fluid chamber 76, a first axial fluid chamber 84 and a second axial fluid chamber 86, respectively. The first radial fluid chamber 74 and the second radial fluid chamber 76 are fluidically connected to each other via a radial fluid channel 78 and configured such that upon a radial relative movement between the inner core 20 and the cage 30 in a radial direction VR, a fluid exchange takes place between the first radial fluid chamber 74 and the second radial fluid chamber 76 via the radial fluid channel 78. The first axial fluid chamber 84 and the second axial fluid chamber 86 are fluidically connected to each other via an axial fluid channel 88 and configured such that upon an axial relative movement between the inner core 20 and the cage 30 in an axial direction AR, a fluid exchange takes place between the first axial fluid chamber 84 and the second axial fluid chamber 86 via the axial fluid channel 88.

For the above-mentioned aspects and in particular for embodiments in this respect, the explanations given above or below also apply to the embodiments of the respective other aspects.

In the following, individual embodiments are described by way of example with reference to the figures. In some cases, the individual embodiments described have features which are not absolutely necessary to carry out the claimed subject matter, but which provide advantageous properties in certain applications. Thus, embodiments which do not have all the features of the embodiments described below are also to be regarded as falling within the scope of the technical teaching described. Furthermore, in order to avoid unnecessary repetition, certain features are mentioned only in relation to individual embodiments described below. It is noted that the individual embodiments should therefore be considered not only in isolation, but also in combination. On the basis of this combination, a person skilled in the art will recognize that individual embodiments can also be modified by including individual or several features of other embodiments. It is pointed out that a systematic combination of the individual embodiments with individual or several features described in relation to other embodiments may be desirable and useful and should therefore be considered and also be regarded as included in the description.

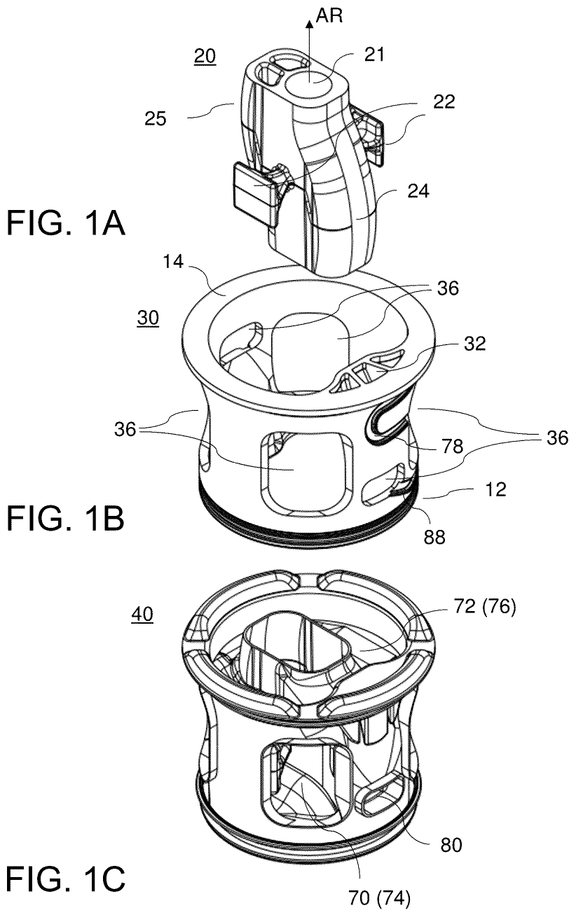

FIGS. 1A to 1C show the individual components of a vulcanization component 100 of a substantially cylindrical hydraulic bearing 10 of the present disclosure in a non-assembled state.

FIG. 1A shows a perspective view of an inner core 20 of the hydraulic bearing 10 of the present disclosure. The inner core 20 is made of a dimensionally stable material such as metal or plastic, is cylindrical in its basic shape in an axial direction AR and has an axial through hole 21 which serves as a mounting recess. The hydraulic bearing 10 may be fixed to a component by a screw or the like introduced into the mounting recess. The inner core 20 has, in sections in the axial direction AR, a first radially protruding thickening region 24 and a second radially protruding thickening region 25 which are arranged diametrically with respect to a center point of the hydraulic bearing 10. The center point of the hydraulic bearing 10 can be regarded here approximately as a center of volume and/or as a center of area in an xy-plane. In addition, as in this embodiment, the inner core 20 may have two radial stops 22 which, in the assembled state of the hydraulic bearing 10, project into a first radial fluid chamber 74 and a second radial fluid chamber 76 and limit the movement to a maximum possible radial movement path upon radial relative movements of the inner core 20 with respect to a cage 30 of the hydraulic bearing 10.

FIG. 1B shows a perspective view of a cage 30 of the hydraulic bearing 10 of the present disclosure. The cage 30 is made of a dimensionally stable material such as plastic and is formed approximately as a hollow cylinder in its basic shape. The axial end faces of the cage 30 are open and in the radial direction, the cage 30 has six through recesses 36 which are provided in cooperation with an elastomer body 40 and an outer sleeve 50 in order to form the two radial fluid chambers 74 and 76 and two axial fluid chambers 84 and 86 each for receiving a working fluid 90.

Here, the through recesses 36 are arranged so as to, in an injection molding method for manufacturing the vulcanization component 100, enable the insertion or passage of sliders in a prescribed radial direction in order to form a first radial fluid chamber recess 70 and a second radial fluid chamber recess 72 in the elastomer body 40. Two sliders are used to form the radial fluid chamber recesses 70 and 72, in which the two sliders may each be inserted into the through recesses 36 in opposite radial directions. Similarly, the through recesses 36 are arranged such that, in the elastomer body 40, a first axial fluid chamber recess 80 is formed by inserting or passing one of the sliders in the radial direction and a second axial fluid chamber recess 82 is formed by inserting or passing the other of the sliders in the opposite radial direction.

The cage 30 has a groove or recess on its outer side for forming a radial fluid channel 78 between the radial fluid chambers 74 and 76, via which the radial fluid chambers 74 and 76 can communicate fluidically. Similarly, the cage 30 has a groove or recess on its outer side for forming an axial fluid channel 88 between the axial fluid chambers 84 and 86, via which the axial fluid chambers 84 and 86 can communicate fluidically. In contrast, the radial fluid chambers 74 and 76 do not have any fluidic connection to the axial fluid chambers 84 and 86.

The cage 30 also has a first support protrusion 32 at a second axial bearing end 14 and a second support protrusion 34 at a first axial bearing end 12 (not visible in FIG. 1B). Here, the first and second support protrusions 32 and 34 each extend in a radial direction towards the z-axis. Together with the first and second radially protruding thickening regions 24 and 25 of the inner core 20 and support spring arms 62 and 64 of a support spring 60 of the elastomer body 40, the support protrusions 32 and 34 increase the axial stiffness of the hydraulic bearing 10.

FIG. 1C shows a perspective view of the elastomer body 40 of the hydraulic bearing 10 of the present disclosure. Here, the elastomer body 40 is shown detached from the inner core 20 and the cage 30 for illustrative purposes only. In particular, the first radial fluid chamber recess 70 and the first axial fluid chamber recess 80 in the elastomer body 40 after injection molding are visible in FIG. 1C, while the second radial fluid chamber recess 72 and the second axial fluid chamber recess 82 are not visible in the perspective view.

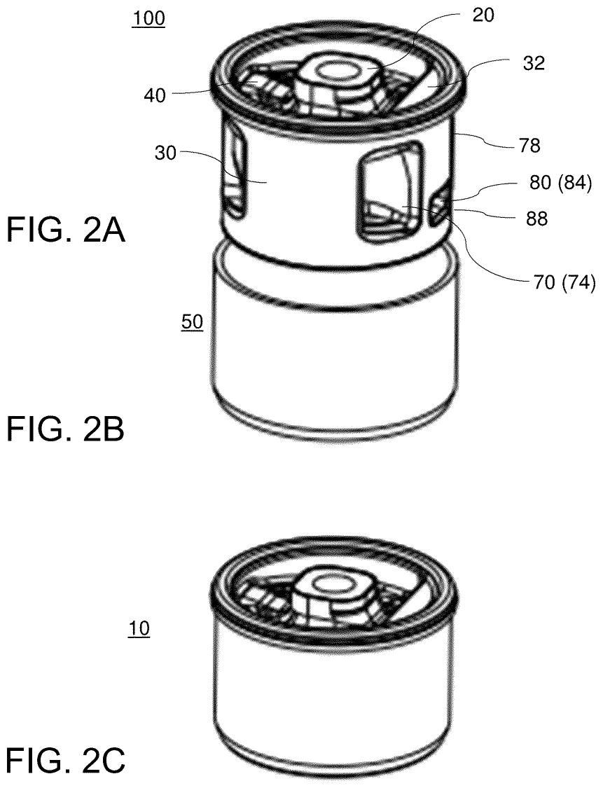

FIG. 2A shows a perspective view of a vulcanization component 100 of the hydraulic bearing 10 of the present disclosure in the connected state of the inner core 20, the cage 30 and the elastomer body 40. Here, on the other hand, the first radial fluid chamber recess 70, the first axial fluid chamber recess 80, the radial fluid channel 78 and the axial fluid channel 88 are visible.

FIG. 2B shows a perspective view of an outer sleeve 50 of the hydraulic bearing 10 of the present disclosure. The outer sleeve 50 is formed as a hollow cylinder made of a dimensionally stable material, wherein the outer contour of the outer sleeve 50 may be connected to a further component. The axial extension of the outer sleeve 50 substantially corresponds to the axial extension of the vulcanization component 100. The inner diameter of the outer sleeve 50 is selected such that the vulcanization component 100 can be press-fitted thereinto up to the axial stop flange at the second axial bearing end 14.

FIG. 2C shows a perspective view of the hydraulic bearing 10 of the present disclosure in the connected state of the vulcanization component 100 and the outer sleeve 50. After press-fitting the vulcanization component 100 into the outer sleeve 50, a part of the inner side of the outer sleeve 50 limits the first and second radial fluid chamber recesses 70 and 72, the first and second axial fluid chamber recesses 80 and 82, the radial fluid channel 78 and the axial fluid channel 88 outwardly in a radial direction and seals them in a fluid-tight manner. Before and/or during the press-fitting of the vulcanization component 100 into the outer sleeve 50, the radial fluid chamber recesses 70 and 72, the axial fluid chamber recesses 80 and 82, the radial fluid channel 78 and the axial fluid channel 88 are filled with the working fluid 90. The connection of the vulcanization component 100 to the outer sleeve 50 thus produces, in the hydraulic bearing 10, the self-contained radial fluid system with the first and second radial fluid chambers 74 and 76 and the radial fluid channel 78 and the self-contained axial fluid system with the first and second axial fluid chambers 84 and 86 and the axial fluid channel 88, in which the two fluid systems are not connected to each other.

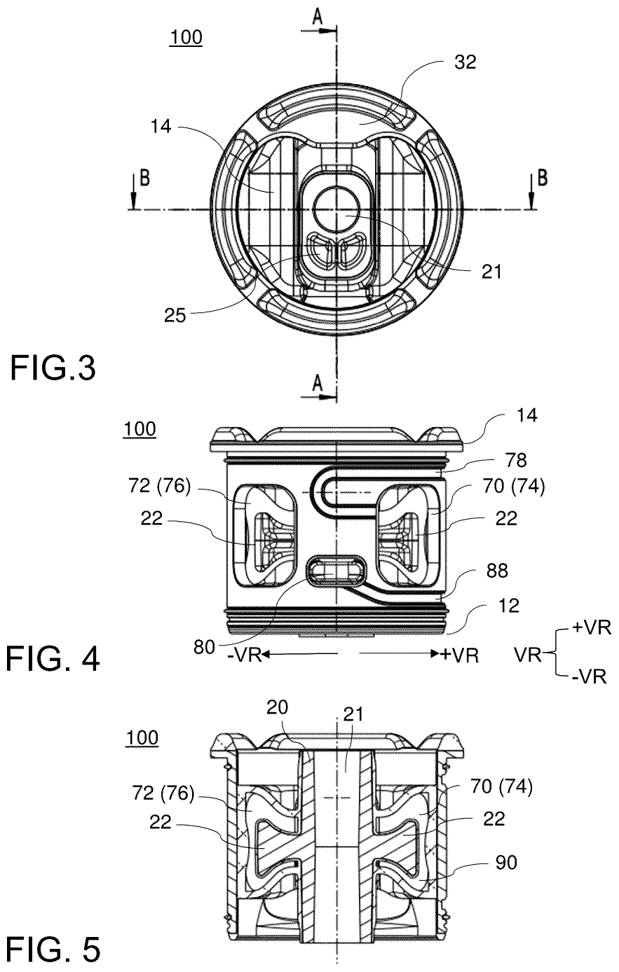

FIG. 3 shows a front view of an axial end face of the vulcanization component 100 of the hydraulic bearing 10 of the present disclosure. Here, the second axial bearing end 14 is visible, which is sealed in a fluid-tight manner in the axial direction by the elastomer body. The first support protrusion 32 is covered with elastomer material of the elastomer body 40. The axial through hole 21 and the second radially protruding thickening region 25 are visible from the inner core 20.

FIG. 4 shows a first side view of the vulcanization component 100 of the hydraulic bearing 10 of the present disclosure. In particular, FIG. 4 provides a view through two of the through recesses 36 (also see FIG. 1B) into the first and second radial fluid chamber recesses 70 and 72 with the radial stops 22 projecting into the recesses and through a further through recess 36 into the first axial fluid chamber recess 80. The axial fluid channel 88 can also be seen, which opens into the first axial fluid chamber recess 80 and connects it to the second axial fluid chamber recess 82, which is not visible in the figure, in the peripheral direction at the outer edge of the cage 30. The radial fluid channel 78 can be seen, which opens into the first radial fluid chamber recess 70 and connects it to the second radial fluid chamber recess 72 in the peripheral direction at the outer edge of the cage 30. Here, the opening into the second radial fluid chamber recess 72 is not visible. Upon radial relative movement of the inner core 20 with respect to the cage 30 under load of the hydraulic bearing in a direction corresponding to a predetermined radial direction VR, the elastic first radial fluid chamber recess 70 is compressed and the working fluid 90 is pressed into the elastic second radial fluid chamber recess 72 via the radial fluid channel 78. This damps the radial relative movement.

FIG. 5 shows a cross-sectional view of the vulcanization component 100 of the hydraulic bearing 10 of the present disclosure of FIG. 4 along its longitudinal axis (section B-B in FIG. 3). Here, in particular, the arrangement of the inner core 20 with the axial through hole 21 and its radial stops 22 in the two radial fluid chamber recesses 70 and 72 is visible in the cross-section.

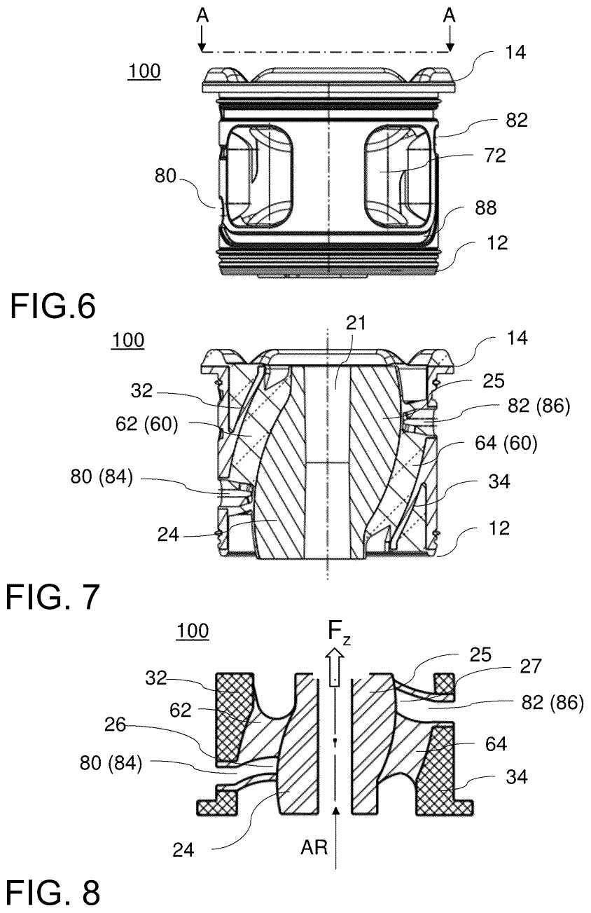

FIG. 6 shows a second side view of the vulcanization component 100 of the hydraulic bearing 10 of the present disclosure. In particular, this provides a further view (rotated by 90° in the peripheral direction with respect to the first view in FIG. 4) through two of the through recesses 36 (also see FIG. 1B) into the second radial fluid chamber recess 72. The axial fluid channel 88 can also be seen, which opens into the first axial fluid chamber recess 80 and second axial fluid chamber recess 82 and connects them to each other in the peripheral direction at the outer edge of the cage 30. The radial fluid channel 78 can also be seen, although no opening into the first and second radial fluid chamber recesses 70 and 72 is visible in the figure.

FIG. 7 shows another cross-sectional view of the vulcanization component 100 of the hydraulic bearing 10 of the present disclosure of FIG. 6 (section A-A in FIG. 3). In particular, the cross-sectional view provides a view into the first and second axial fluid chamber recesses 80 and 82 of the elastomer body 40. The first and second radially protruding thickening regions 24 and 25 of the inner core 20, the first and second support protrusions 32 and 34 of the cage 30 and first and second support spring arms 62 and 64 of the support spring 60, which are formed by the elastomer body, can also be seen. Here, on a first radial side (left side of the vulcanization component 100 in FIG. 7), the first radially protruding thickening region 24 and the first support protrusion 32 at least partially enclose the first support spring arm 62 in an approximately axial direction. Diametrically with respect to the center of the hydraulic bearing (for example, its center of volume and/or its center of area in an xy-plane), the arrangement on the first radial side is also formed on the second opposite radial side (right side of the vulcanization component 100 in FIG. 7). Here, the second radially protruding thickening region 25 and the second support protrusion 34 at least partially enclose the second support spring arm 64 in an approximately axial direction. This increases the axial stiffness of the hydraulic bearing 10.

FIG. 8 shows a schematic axial cross-sectional view of the vulcanization component 100 of the hydraulic bearing 10 of the present disclosure under axial load. Here, the schematic illustration in FIG. 8 corresponds to the arrangement of FIG. 7. In an assembled state of the hydraulic bearing 10 and upon axial relative movement of the inner core 20 with respect to the cage 30 under load F_{z} of the hydraulic bearing 10 in a direction along the axial direction AR, the first axial fluid chamber recess 80, which forms the first axial fluid chamber 84 in the assembled state, is compressed by the first support spring arm 62 and at a first pressing surface 26 of the first radially protruding thickening region 24 and the working fluid 90 is pressed into the elastic second axial fluid chamber recess 82, which forms the second axial fluid chamber 86 in the assembled state, via the axial fluid channel 88. This damps the axial relative movement. Upon subsequent opposing axial relative movement of the inner core 20 with respect to the cage 30 under a negative load F_{z} of the hydraulic bearing in a direction along the negative axial direction AR, the second axial fluid chamber recess 82 is compressed by the second support spring arm 64 and at a second pressing surface 27 of the second radially protruding thickening region 25 and the working fluid 90 is pressed into the elastic first axial fluid chamber recess 80 via the axial fluid channel 88.

What is claimed is:

1. A hydraulic bearing, comprising:
an inner core;
a cage, surrounding the inner core;
an elastomer body, extending between the inner core and the cage, and elastically connecting the inner core and the cage to each other; and
an outer sleeve, enclosing the cage,
wherein the elastomer body comprises:
a support spring;
a first radial fluid chamber recess and a second radial fluid chamber recess; and
a first axial fluid chamber recess and a second axial fluid chamber recess,
wherein the first radial fluid chamber recess, the second radial fluid chamber recess, the first axial fluid chamber recess and the second axial fluid chamber recess are each filled with a working fluid and limited radially outwardly by the outer sleeve to form a first radial fluid chamber, a second radial fluid chamber, a first axial fluid chamber and a second axial fluid chamber, respectively,
wherein the first radial fluid chamber and the second radial fluid chamber are fluidically connected to each other via a radial fluid channel and configured such that upon a radial relative movement between the inner core and the cage in a radial direction, a fluid exchange takes place between the first radial fluid chamber and the second radial fluid chamber via the radial fluid channel, and
wherein the first axial fluid chamber and the second axial fluid chamber are fluidically connected to each other via an axial fluid channel and configured such that upon an axial relative movement between the inner core and the cage in an axial direction, a fluid exchange takes place between the first axial fluid chamber and the second axial fluid chamber via the axial fluid channel.

2. The hydraulic bearing according to claim 1, wherein
the elastomer body is provided to be substantially free of undercuts at its axial end faces in the axial direction, and/or
the elastomer body and the cage are provided to be substantially free of undercuts in a region of the first radial fluid chamber recess, the second radial fluid chamber recess, the first axial fluid chamber recess and the second axial fluid chamber recess at least in a first radial direction and a second radial direction opposing each other, wherein the radial direction includes the first radial direction and the second radial direction opposing each other.

3. The hydraulic bearing according to claim 1, wherein
the support spring has a first support spring arm and a second support spring arm each extending from the inner core to the cage at substantially diametrical positions,
wherein the first radial fluid chamber and the second radial fluid chamber are limited in a circumferential direction by the first support spring arm and the second support spring arm, and
wherein the first axial fluid chamber is limited by the first support spring arm and the second axial fluid chamber is limited by the second support spring arm in the axial direction.

4. The hydraulic bearing according to claim 3, wherein
the first axial fluid chamber is arranged on a side of a first axial bearing end of the first support spring arm, and
the second axial fluid chamber is arranged on a side of a second axial bearing end of the second support spring arm.

5. The hydraulic bearing according to claim 4, wherein
the inner core has a first radially protruding thickening region and a second radially protruding thickening region,
wherein the first radially protruding thickening region is provided in the circumferential direction at a position corresponding to the first support spring arm, and the second radially protruding thickening region is provided in the circumferential direction at a position corresponding to the second support spring arm,
wherein the first radially protruding thickening region is offset in the axial direction relative to the second radially protruding thickening region towards the first axial bearing end.

6. The hydraulic bearing according to claim 5, wherein
the first radially protruding thickening region has a first pressing surface which, at least in sections, adjoins the first axial fluid chamber in the axial direction, and
the second radially protruding thickening region has a second pressing surface which, at least in sections, adjoins the second axial fluid chamber in the axial direction.

7. The hydraulic bearing according to claim 4, wherein
the cage has:
a first support protrusion, disposed at the second axial bearing end, and
a second support protrusion, disposed at the first axial bearing end,
wherein
the first support protrusion is provided in the circumferential direction at a position corresponding to the first support spring arm, and
the second support protrusion is provided in the circumferential direction at a position corresponding to the second support spring arm.

8. A method for manufacturing a hydraulic bearing, comprising:
placing an inner core in a mold or a tool;
placing a cage in the mold, such that the cage surrounds the inner core;
closing the mold;
inserting radial sliders into the mold;
injecting an elastomer material into the mold;
completely vulcanizing the elastomer material in order to form an elastomer body which elastically connects the inner core and the cage, wherein the elastomer body has a support spring, a first radial fluid chamber recess, a second radial fluid chamber recess, a first axial fluid chamber recess and a second axial fluid chamber recess, and molding a vulcanization component, wherein the vulcanization component has the inner core, the elastomer body and the cage;
pulling out the radial sliders;
opening the mold;
demolding the vulcanization component from the mold; and
connecting the vulcanization component to an outer sleeve;
wherein
the first radial fluid chamber recess, the second radial fluid chamber recess, the first axial fluid chamber recess and the second axial fluid chamber recess are each filled with a working fluid and limited radially outwardly by the outer sleeve to form a first radial fluid chamber, a second radial fluid chamber, a first axial fluid chamber and a second axial fluid chamber, respectively,
wherein the first radial fluid chamber and the second radial fluid chamber are fluidically connected to each other via a radial fluid channel and configured such that upon a radial relative movement between the inner core and the cage in a radial direction, a fluid exchange takes place between the first radial fluid chamber and the second radial fluid chamber via the radial fluid channel, and
wherein the first axial fluid chamber and the second axial fluid chamber are fluidically connected to each other via an axial fluid channel and configured such that upon an axial relative movement between the inner core and the cage in an axial direction, a fluid exchange takes place between the first axial fluid chamber and the second axial fluid chamber via the axial fluid channel.
